(19) United States
(12) Patent Application Publication
(10) Pub. No.: US 2026/0061462 A1
(43) Pub. Date: Mar. 5, 2026

(54) Sealed Water Jet System for High Temperatures

(71) Applicant: PETRÓLEO BRASILEIRO S.A. - PETROBRAS, Rio de Janeiro (BR)

(72) Inventors: Daniel Zumpano Guerrero, Paulínia (BR); Claudio Antonio Antunes de Souza, Paulínia (BR)

(73) Assignee: PETRÓLEO BRASILEIRO S.A. - PETROBRAS, Rio de Janeiro (BR)

(21) Appl. No.: 19/310,023

(22) Filed: Aug. 26, 2025

(30) Foreign Application Priority Data
Aug. 30, 2024 (BR) 1020240178912

(51) Int. Cl. B08B 3/02

(52) U.S. Cl. CPC B08B 3/02

(57) ABSTRACT

The present invention relates to a sealed water jet system for unclogging pipelines in operation, comprising: at least one high-pressure pump; at least one oil reservoir; at least one high-pressure hose; a high-pressure boom; at least one nitrogen source; at least one sealing subsystem comprising: a nitrogen inlet; a primary seal with gaskets; a chamber inertized with nitrogen; and a secondary seal with gaskets.

### CROSS-REFERENCE TO RELATED APPLICATIONS

This application claims priority to Brazilian Application No. BR1020240178912 filed on Aug. 30, 2024, the disclosure of which is expressly incorporated herein by reference in its entirety.

### FIELD OF THE INVENTION

The present invention pertains to the technical field of maintenance and operation of industrial units, especially in oil refinery systems, where the unclogging of pipelines and equipment operating at high temperatures is necessary.

More specifically, the system of the present invention was applied in the Delayed Coking Unit (DCU), where the fines removal system of the fractionating tower requires effective methods for unclogging the bottom circulation systems of the tower, without interrupting the operation.

### BACKGROUND OF THE INVENTION

The objective of the invention is to solve the problem of clogging in systems that operate at high temperatures and with hydrocarbons.

The clogs may interrupt the flow and cause unplanned shutdowns, generating operational losses and safety risks. Traditional methods, such as water jetting, are not viable due to the risks of thermal expansion and damage to equipment.

In this sense, the present invention proposes a water jet system using a driving fluid compatible with the operating conditions of the equipment in question. In this case, a lubricating oil was selected.

This system consists of equipment adapted with special materials, a triple sealing system with gaskets and nitrogen, and welding techniques in operation. The solution allows a safe and effective unclogging, without the need to shut the equipment down, mitigating operational risks and maintaining process continuity.

### RELATED ART

Document CN117797493A presents a method for recovering residual lubricating oil in refineries. Initially, the residual oil is sent to a dirty oil tank through a discharge facility. In this tank, the residual oil mixes with the dirty oil, forming a mixture called mixed dirty oil. This mixture is then pumped to the top of a ventilation tower, where it is heated and sprayed to remove light components. The bottom residual oil is then mixed with hot heavy oil and sent to a coking tower. The output from the coking tower is routed to a distillation tower where different products such as naphtha, coke diesel and coke oil are separated.

Document WO202216885A1 presents a series of embodiments related to isolation valves, with emphasis on valves used in bottom residue circuits in fluidized catalytic cracking units (FCCU). These valves are purged using hydrocarbons such as heavy coke oils (HCO), medium coke oils (MCO) or light coke oils (LCO). The liquid purge system is designed to keep the internal parts of the valve clean and free of deposits or residues, thus extending its service life and ensuring its proper operation.

Therefore, it is clear that, while the documents of the state of the art focus on the recovery of residual lubricating oil or the purging of valves, the present invention directly addresses to the unclogging of pipelines and equipment in DCUs, where frequent clogs occur due to the accumulation of coke fines.

In addition, the present invention introduces a triple sealing system with gaskets and a nitrogen inerting chamber, ensuring the safety of the performers during the unclogging. Added to this is the fact that, unlike the methods that require equipment shutdown, the present invention allows unclogging without interrupting the operational process. This significantly reduces operational risks and losses associated with unplanned shutdowns.

### SUMMARY OF THE INVENTION

The present invention proposes a sealed water jet system for unclogging the pipelines of a fractionating tower, comprising: at least one high-pressure pump; at least one oil reservoir; at least one high-pressure hose; a high pressure boom; at least one nitrogen source; at least one sealing subsystem comprising: a nitrogen inlet; a primary gasket seal; a chamber inertized with nitrogen; and a secondary gasket seal.

### BRIEF DESCRIPTION OF THE DRAWINGS

The present invention will be described below with reference to its typical embodiments and with reference to the attached drawings, in which:

FIG. 1 is a representation of the bottom of the fractionating tower of a delayed coking unit, with its system for removing fines.

FIG. 2 is a representation of the triple sealing system of the present invention.

FIG. 3 is a schematic representation of all the components of the proposed system.

FIG. 4 is a representation of the delayed coking unit where two shunts were made: horizontal and vertical.

### DETAILED DESCRIPTION OF THE INVENTION

Delayed Coking is an oil refining process that converts heavy residues into more valuable products, such as refinery gas, naphtha, diesel and coke. The existence of a Delayed Coking Unit (DCU) is crucial to maximize the use of crude oil, especially in refineries that process heavy oils.

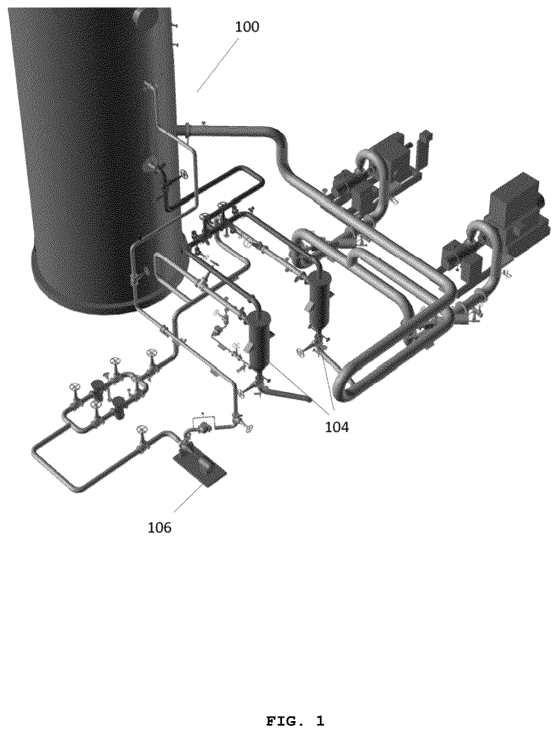

As presented in FIG. 1, one of the main components of the DCU is the fractionator (100), where the lighter components, such as gases and light liquids, are separated from the heavier streams. The bottom stream from the fractionator (100) is directed to a fines removal system, where the fines are separated in fines decanting vessels (104), and the stream theoretically free of fines is recirculated to the fractionator (100) by the recirculation pump (106).

This recirculation, however, can cause clogs in the system, which lead to the need to perform cleaning procedures with countercurrent flow, aiming to push the fines back into the tower and thus reestablish the flow. However, some clogs are so severe that these countercurrent operational maneuvers are ineffective, not even with modifications to the system to increase the pressure of this countercurrent flow to the maximum permitted by the system.

In this sense, the present invention proposes a sealed water jet system with lubricating oil to unclog the system in operation, resuming the functionality of the system to remove coke fines from the bottom of the fractionator. This system is equipped with:
at least one high-pressure pump (300);
at least one oil reservoir (302);
at least one high-pressure hose (304);
a high-pressure boom (200);
a high-pressure nozzle (210);
at least one nitrogen source (308);
at least one sealing subsystem (214) comprising:
a nitrogen inlet (202);
a primary seal with gaskets (204);
a chamber inertized with nitrogen (206); and
a secondary seal with gaskets (208).

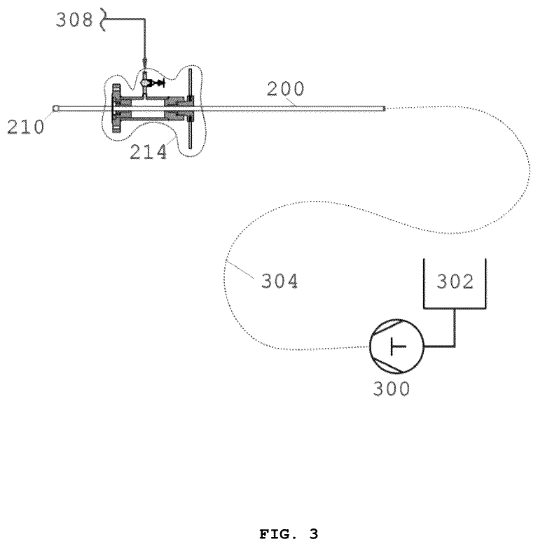

The high-pressure pump (300), as shown in FIG. 3, is connected to the oil reservoir (302), which stores lubricating oil, by means of a high-pressure hose (304). The function of the lubricating oil is to act as a fluid to unclog the system, breaking down the deposits that cause the clogging (coke fines) and dragging the same through the outlet pipeline from the bottom of the fractionator to the fines decanting vessels. The lubricating oil is capable of operating in high temperature conditions (above 100° C.) without vaporizing, unlike water jetting, since water, when changing phase, could cause damage to the equipment due to the large volumetric variation (expansion). The high pressure of the lubricating oil, by means of water jet nozzles (210), promotes the breaking down of coke deposits by mechanical action, efficiently unclogging the pipelines and equipment.

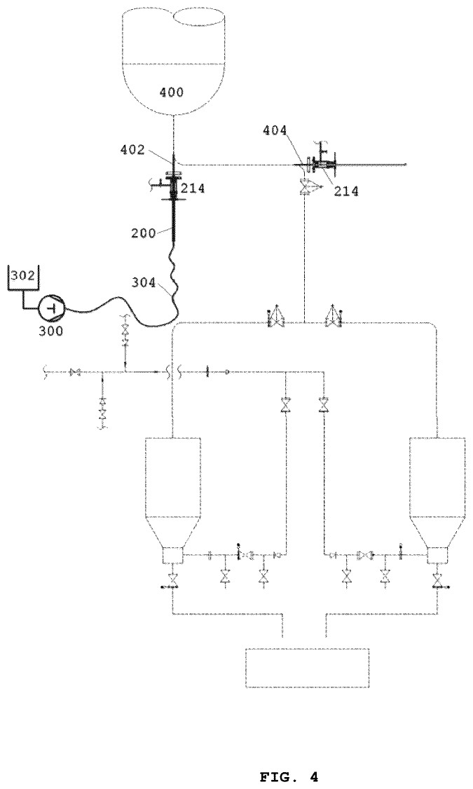

Associated with the high-pressure mechanism, which is the high-pressure pump (300) and its respective oil reservoir (302), it was necessary to create shunts in the bottom pipelines of the fractionator (400), in order to allow access for unclogging. Two shunts were created in the clogged section, as shown in FIG. 4, one horizontal (402) and the other vertical (404).

For the horizontal shunt (404), external to the skirt of the fractionator (400), it was necessary to qualify the welding procedure to coat/overlay weld alloy steel with 5% Cr without performing a stress relief heat treatment. For welding the shunt of the vertical section (402) (inside the skirt of the fractionator), a direct welding of the shunt was carried out.

Sealing subsystems (214) are installed in these branches (402 and 404), which have the function of guaranteeing the safety of the operators and the integrity of the system during the unclogging process, preventing leaks and failures.

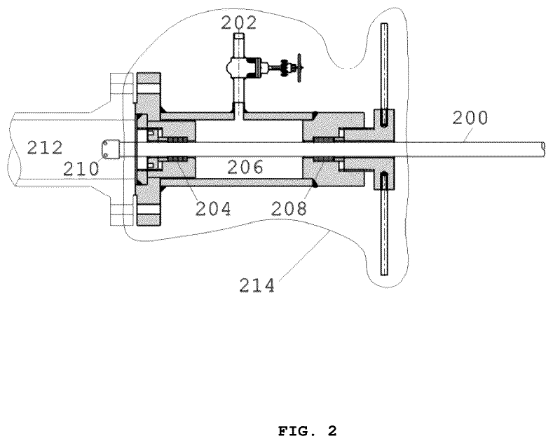

The sealing subsystems (214), as shown in FIG. 2, have a primary seal with gaskets (204) made of materials resistant to high temperatures and hydrocarbons, with the function of acting as the first line of blocking against the leakage of hydrocarbons from the pressurized system to the atmosphere, acting directly on the interface between the insertion device of the water jet boom (200), containing a high-pressure nozzle (210), and the fractionator pipeline (212).

In addition, there is also a nitrogen inerting chamber (206), being an additional barrier against the leakage of hydrocarbons to the environment, fed by the nitrogen source (308) through the nitrogen inlet (202). The chamber is maintained at a pressure higher than the internal pressure of the equipment. If there is any leakage through the gaskets, the nitrogen creates a barrier preventing the escape of hydrocarbons to the environment.

There is further a secondary seal with gaskets (208), similar to the primary seal, which is a redundancy in case of failure in the previous systems.

### Example of Use

After completing the shunt and installing the sealing subsystem, the TIE-IN manual valve must be opened so that the high-pressure boom, inserted through the sealing device, reaches the clogging area inside the equipment.

Then, the water jet boom is moved back and forth to unclog the pipe. The high pressure of the lubricating oil (approximately 1,000 bar (100 MPa)) will break and remove the existing mechanical barrier (clogging).

The unclogging begins with the horizontal section of the fractionator. The water jet boom is moved along the horizontal section to ensure complete removal of the fines in this area.

Once the cleaning of the horizontal section is complete, the same procedure of inserting and removing the boom is repeated to completely clean the vertical section up to the inlet at the bottom of the fractionator.

After the unclogging is complete, the water jet boom is removed from the system, ensuring that the TIE-IN manual valve is closed.

What is claimed is:

1. A sealed water jet system for unclogging pipes in operation at high temperatures comprising:
at least one high-pressure pump;
at least one oil reservoir;
at least one high-pressure hose;
a high-pressure boom;
at least one nitrogen source;
at least one sealing subsystem comprising:
a nitrogen inlet;
a primary seal with gaskets;
a chamber inertized with nitrogen; and
a secondary seal with gaskets.

2. The system according to claim 1, wherein the high-pressure boom comprises a high-pressure nozzle.

3. The system according to claim 1, wherein the pressure of the chamber inertized with nitrogen must always be greater than the internal pressure of the fractionator pipeline.

4. The system according to claim 1, wherein one of the sealing subsystems is installed in the horizontal section of the fractionator inlet pipeline.

5. The system according to claim 1, wherein one of the sealing subsystems is installed in the vertical section of the inlet pipeline of the fractionator.

6. The system according to claim 1, wherein the jetting fluid is selected according to the operating conditions of the equipment, so as to avoid damage caused by its sudden vaporization.
